(19) United States
(12) Patent Application Publication
(10) Pub. No.: US 2026/0053127 A1
(43) Pub. Date: Feb. 26, 2026

(54) Fishing rod line guides

(71) Applicant: Protos, LLC, Boise, ID (US)

(72) Inventor: Daniel Martin Uribe, San Antonio, TX (US)

(21) Appl. No.: 19/256,249

(22) Filed: Jul. 1, 2025

Related U.S. Application Data
(62) Division of application No. 29/992,882, filed on Mar. 11, 2025.
Application No. 29/992,882 is a division of application No. 29/958,718, filed on Aug. 21, 2024, now Pat. No. D1074918.

(51) Int. Cl. A01K 87/04; C23C 18/32

(52) U.S. Cl. CPC A01K 87/04; C23C 18/32

(57) ABSTRACT

A fishing rod line guide system is disclosed that provides improved casting performance, reduced line wear, and superior heat dissipation for both freshwater and saltwater fishing applications. The system comprises a plurality of guides constructed from titanium alloy wire, each guide sized and shaped according to the intended fishing line weight, with dimensional scaling that maintains proportional relationships between outer diameter, inner diameter, and frame length across guide sizes from 6.0 to 20 H casting models. Each guide frame is coated with an electroless nickel-polytetrafluoroethylene (PTFE) composite layer, resulting in a uniformly low-friction surface that significantly reduces line adhesion and wear compared to conventional PVD-coated stainless steel guides. The synergistic combination of titanium Grade 5 construction, dimensional scaling, and ultra-low friction PTFE coating enables enhanced anti-tangle properties, improved casting distance and accuracy, and effective heat management, thereby addressing persistent challenges in conventional fishing rod guide design.

### CROSS-REFERENCE TO RELATED APPLICATIONS

See Application Data Sheet (ADS).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The present specification relates generally to fishing rod line guides and more particularly to improved fishing rod guides incorporating titanium alloy wire frame construction combined with electroless nickel-polytetrafluoroethylene (PTFE) coating to provide enhanced casting performance, reduced line wear, and superior heat dissipation characteristics for both freshwater and saltwater fishing applications.

### Listing of the Prior Art

The following references might be to be related to the disclosed subject matter:

### U.S. Patents

U.S. Pat. No. 39,670 A—August 1863
U.S. Pat. No. 682,730 A—Sep. 17, 1901
U.S. Pat. No. 1,627,643 A—May 10, 1927
D101,236 S—Sep. 15, 1936
D108,720 S—Mar. 8, 1938
U.S. Pat. No. 2,146,964 A—Feb. 14, 1939
D118,586 S—Jan. 16, 1940
D139,411 S—Nov. 14, 1944
D141,643 S—Jun. 19, 1945
D143,398 S—Jan. 1, 1946
U.S. Pat. No. 2,398,862 A—Apr. 23, 1946
U.S. Pat. No. 2,573,647 A—Oct. 30, 1951
U.S. Pat. No. 2,623,317 A—Dec. 30, 1952
U.S. Pat. No. 2,702,959 A—Feb. 12, 1952
U.S. Pat. No. 2,721,412 A—Oct. 25, 1955
U.S. Pat. No. 2,775,054 A—Dec. 25, 1956
U.S. Pat. No. 3,060,618 A—Oct. 30, 1962
D203,273 S—Dec. 21, 1965
U.S. Pat. No. 3,403,468 A—Oct. 1, 1968
D237,175 S—Oct. 14, 1975
U.S. Pat. No. 4,174,583 A—Nov. 20, 1979
D255,701 S—Jul. 1, 1980
D256,492 S—Aug. 19, 1980
D256,714 S—Sep. 2, 1980
D256,718 S—Sep. 2, 1980
D261,412 S—Oct. 20, 1981
D261,918 S—Nov. 17, 1981
D261,919 S—Nov. 17, 1981
D269,898 S—Jul. 26, 1983
D346,849 S—May 10, 1994
U.S. Pat. No. 5,361,529 A—Nov. 8, 1994
U.S. Pat. No. 5,802,759 A—Sep. 8, 1998
D423,076 S—Apr. 18, 2000
U.S. Pat. No. 6,612,065 B1—Sep. 2, 2003
D484,216 S—Dec. 23, 2003
D494,249 S—Aug. 10, 2004
D495,774 S—Sep. 7, 2004
U.S. Pat. No. 6,851,216 B2—Feb. 8, 2005
D507,623 S—Jul. 19, 2005
D611,564 S—May 9, 2010
D636,839 S—Apr. 26, 2011
D644,709 S—Sep. 6, 2011
D659,792 S—May 15, 2012
D668,317 S—Oct. 2, 2012
D677,751 S—Mar. 12, 2013
D699,316 S—Feb. 11, 2014
D715,397 S—Oct. 27, 2014
U.S. Pat. No. 9,066,506 B2—Jun. 30, 2015
D767,089 S—Sep. 6, 2016
U.S. Pat. No. 9,456,594 B2—Oct. 4, 2016
U.S. Pat. No. 9,591,836 B2—Mar. 14, 2017
U.S. Pat. No. 10,149,465 B2—Dec. 11, 2018
U.S. Pat. No. 10,561,129 B2—Feb. 18, 2020
D912,760 S—Mar. 23, 2021
D1,013,095 S—January 2024

### U.S. Patent Application Publications

2010/0101136 A1—Apr. 29, 2010
2021/0112795 A1—Apr. 22, 2021
   See references cited in the priority documents.

### BACKGROUND OF THE INVENTION

Fishing rod line guides serve the critical function of directing fishing line along the rod during casting and retrieving operations while minimizing friction and line damage. Traditional fishing rod guides have employed various materials and construction methods, each with inherent limitations that affect casting performance, line durability, and overall fishing effectiveness.

Conventional fishing rod guides typically utilize either ceramic inserts or metal frames with surface treatments. Ceramic insert systems, while providing smooth line contact surfaces, suffer from several disadvantages. Silicon carbide (SiC) and aluminum oxide ceramic inserts, though offering good friction characteristics, are brittle and prone to cracking or chipping when subjected to impact. Such damage creates sharp edges that can immediately cut or fray fishing line, leading to costly line failures and lost fish. Additionally, ceramic inserts require precise mounting within metal frames, and the epoxy bonding between ceramic and metal components can fail over time, causing inserts to pop out during use.

Metal guide systems have traditionally relied on stainless steel construction with Physical Vapor Deposition (PVD) coatings for surface treatment. While PVD coatings provide some friction reduction and corrosion resistance, they suffer from several technical limitations. PVD coating processes can result in uneven coating thickness, poor adhesion, and contamination issues that compromise performance. Furthermore, PVD coatings typically exhibit higher coefficients of friction compared to more advanced surface treatments, limiting their effectiveness in reducing line wear and heat generation.

Heat generation during fishing operations presents a significant technical challenge that has been largely overlooked in conventional guide design. When fishing line passes through guides under tension, particularly during long runs by large fish or high-speed retrieval, friction between the line and guide surfaces generates substantial heat. This heat buildup can weaken monofilament and fluorocarbon lines, reduce their tensile strength, and in extreme cases, cause line failure. The problem is particularly acute with conventional guides that have poor heat dissipation characteristics and high friction coefficients.

Line tangling represents another persistent problem in fishing rod guide design. Traditional guide geometries can cause fishing line to wrap around guide frames during casting or when slack line is present, resulting in reduced casting distance, casting accuracy problems, and lost fishing time. While some manufacturers have attempted to address this issue with modified frame shapes, these solutions have generally been limited to specific guide styles without addressing the underlying material and coating limitations.

The fishing industry has recognized the need for advanced materials in guide construction. Titanium has emerged as an attractive alternative to stainless steel due to its superior strength-to-weight ratio, excellent corrosion resistance in saltwater environments, and superior thermal conductivity for heat dissipation. Some manufacturers have introduced titanium-framed guides with ceramic inserts, but these designs still rely on brittle ceramic contact surfaces and fail to optimize the thermal properties of titanium construction.

Recent developments in electroless coating technology outside of the fishing industry have demonstrated significant advantages over traditional PVD processes. Electroless nickel-PTFE (Teflon) coatings provide superior friction reduction compared to typical PVD coatings. These composite coatings combine the wear resistance and hardness of electroless nickel with the exceptional lubricity of PTFE, creating surfaces that can reduce friction compared to conventional treatments. The electroless deposition process ensures uniform coating thickness even on complex geometries and provides excellent adhesion to titanium substrates.

Despite these technological advances, the fishing industry has not yet adopted electroless nickel-PTFE coatings for guide applications. While this coating technology has proven successful in aerospace, automotive, food processing, and medical device applications, its specific benefits for fishing rod guides have not been fully realized or commercialized. Despite the availability of advanced materials and coatings in other industries, there is no prior art that discloses or suggests the specific combination of titanium alloy wire with electroless nickel-PTFE coating for fishing rod guides, nor the synergistic benefits of this combination for reducing line tangling, friction, and heat generation in fishing applications.

The combination of titanium alloy wire construction (e.g., grade 5) with electroless nickel-PTFE coating presents an opportunity to address multiple technical challenges simultaneously: reducing friction and heat generation, improving corrosion resistance, minimizing line wear, and incorporating anti-tangle frame geometry. However, prior art has not disclosed the specific benefits achievable through this material combination or demonstrated how to optimize these technologies for fishing applications.

Therefore, there exists a need in the art for fishing rod guides that overcome the limitations of conventional ceramic insert and PVD-coated systems by providing superior friction reduction, enhanced heat dissipation, improved corrosion resistance, reduced line wear, and anti-tangle design features through the strategic combination of advanced materials and coating technologies specifically optimized for fishing applications.

### SUMMARY OF THE INVENTION

In view of the foregoing, an object of this specification is to disclose improved fishing line guides. The present specification provides fishing rod line guides constructed from titanium alloy wire and treated with an electroless nickel-polytetrafluoroethylene (PTFE) coating. The guides feature an innovative anti-tangle frame design that prevents line wrapping while providing superior performance characteristics compared to conventional ceramic insert or PVD-coated steel guides. The titanium alloy wire construction offers exceptional strength-to-weight ratio, corrosion resistance, and heat dissipation properties, while the nickel-PTFE coating provides significantly reduced friction coefficients compared to traditional PVD coatings. This combination enables enhanced casting distance and accuracy, reduced line wear and damage, and improved overall fishing performance through the synergistic effects of frame geometry, advanced materials and coating technology. The invention further includes a range of guide sizes, each with proportional dimensional relationships, ensuring optimal anti-tangle and performance characteristics across all fishing line weights, from light freshwater to heavy saltwater applications.

### BRIEF DESCRIPTION OF THE SEVERAL VIEWS OF THE DRAWINGS

The nature and intended use of the article in which the design is embodied is apparent from the figures and the title of “fishing rod line guides.” Other objectives of the disclosure will become apparent to those skilled in the art once the invention has been shown and described. The manner in which these objectives and other desirable characteristics can be obtained is explained in the following description and attached figures in which:

FIG. 1 is a perspective view of a spinning model fishing rod line guide;

FIG. 2 is a side view of the spinning model fishing rod line guide;

FIG. 3 is a front view of the spinning model fishing rod line guide;

FIG. 4 is a side view of a second embodiment of a spinning model fishing rod line guide;

FIG. 5 is a front view of the second embodiment of the spinning model fishing rod line guide;

FIG. 6 is a side view of a third embodiment of a spinning model fishing rod line guide;

FIG. 7 is a front view of the third embodiment of the spinning model fishing rod line guide;

FIG. 8 is a perspective view of a casting model fishing rod line guide;

FIG. 9 is a front view of the cast model fishing rod line guide;

FIG. 10 is a side view of the casting model fishing rod line guide;

FIG. 11 is a front view of a second embodiment of a casting model fishing rod line guide;

FIG. 12 is a side view of the second embodiment of the casting model fishing rod line guide;

FIG. 13 is a front view of a third embodiment of a casting model fishing rod line guide;

FIG. 14 is a side view of the third embodiment of the casting model fishing rod line guide;

FIG. 15 is a front view of a fourth embodiment of a casting model fishing rod line guide;

FIG. 16 is a side view of the fourth embodiment of the casting model fishing rod line guide;

FIG. 17 is a perspective view of a running line guide.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

A preferred embodiment of the invention is illustrated in the accompanying drawings, which show various embodiments of geometrically optimized fishing rod line guides incorporating titanium alloy wire construction with electroless nickel-PTFE coating. Various titanium alloys (e.g., Grades 1, 2, 5, 9, etc.) can be used depending on the desired balance of strength, flexibility, corrosion resistance, and cost. While Grade 5 is preferred for certain applications due to its strength-to-weight ratio, other grades may be selected for increased flexibility or other performance characteristics. The drawings include both spinning model guides and casting model guides in multiple size configurations, demonstrating the anti-tangle frame geometry and dimensional specifications optimized for different fishing line weights and applications. The combination of titanium alloy wire, electroless nickel-PTFE coating, and optimized frame geometry creates a guide system where each element enhances the others, resulting in superior anti-tangle, friction reduction, and heat dissipation compared to conventional guides.

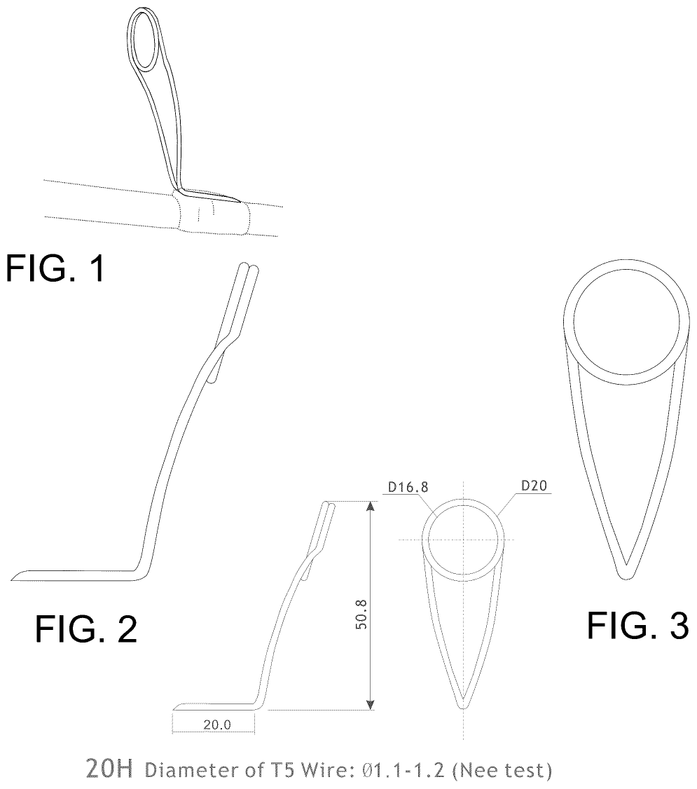

FIG. 1 is a perspective view of a spinning model fishing rod line guide. FIGS. 2 and 3 are respectively a side view and a front view thereof the spinning model fishing rod line guide. FIGS. 1-3 illustrate the first embodiment of a spinning model fishing rod line guide designed for 20 H fishing guide size applications. FIG. 1 provides a perspective view showing the overall three-dimensional configuration of the guide, including the characteristic anti-tangle frame geometry. FIG. 2 depicts the side view profile, while FIG. 3 shows the front view cross-section. This embodiment features an outer ring diameter (D20) of 20.0 millimeters and an inner ring diameter (D16.8) of 16.8 millimeters, with an overall guide length of 50.8 millimeters and a 20.0 millimeter footing. The frame is constructed from titanium alloy wire having a diameter of 1.1-1.2 millimeters, providing optimal strength and durability for heavier line applications.

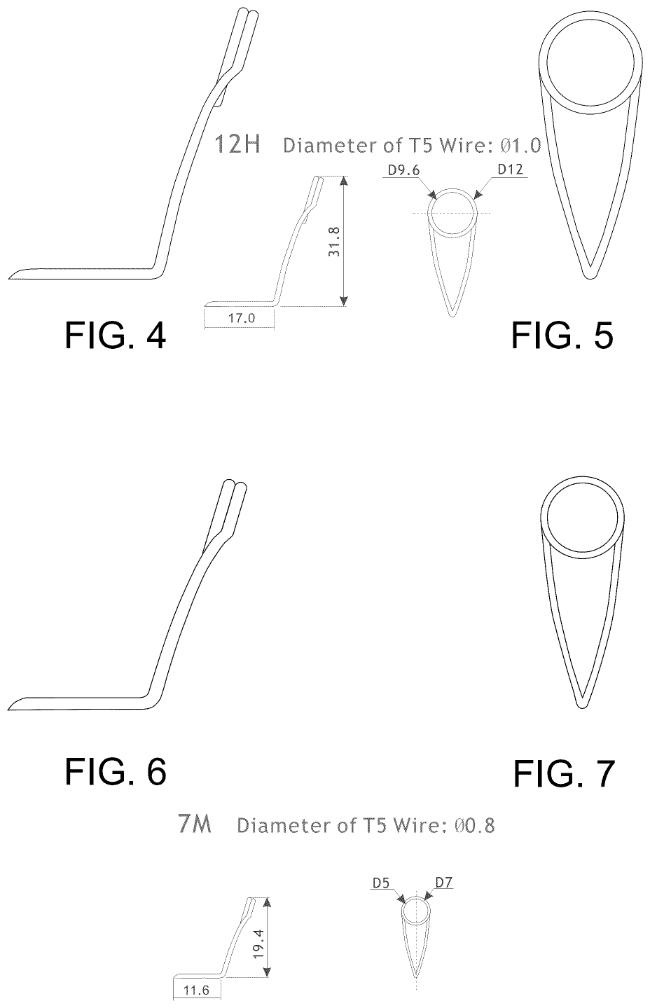

FIG. 4 is a side view of a second embodiment of a spinning model fishing rod line guide. FIG. 5 is a front view thereof the second embodiment of the spinning model fishing rod line guide. FIGS. 4 and 5 show a second embodiment of the spinning model guide optimized for 12 H fishing guide size applications. FIG. 4 presents the side view while FIG. 5 shows the front view configuration. This embodiment incorporates an outer diameter (D12) of 12.0 millimeters and an inner diameter (D9.6) of 9.6 millimeters. The guide features dual length configurations of 31.8 millimeters to accommodate different rod positioning requirements. The guide features a 17.0 millimeter footer. The titanium alloy wire diameter is reduced to 1.0 millimeters for this lighter-duty application, maintaining structural integrity while reducing overall guide weight.

FIG. 6 is a side view of a third embodiment of a spinning model fishing rod line guide. FIG. 7 is a front view of the third embodiment thereof. FIGS. 6 and 7 illustrate a third embodiment configured for 7M fishing guide size applications. The side view in FIG. 6 and front view in FIG. 7 demonstrate the compact design optimized for lighter line weights. This embodiment features an outer diameter (D7) of 7.0 millimeters and an inner diameter (D5) of 5.0 millimeters, with a guide length of 19.4 millimeters and a footer of 11.6 millimeters. The titanium alloy wire maintains a 0.8-millimeter diameter, providing adequate strength while minimizing guide profile for enhanced casting performance.

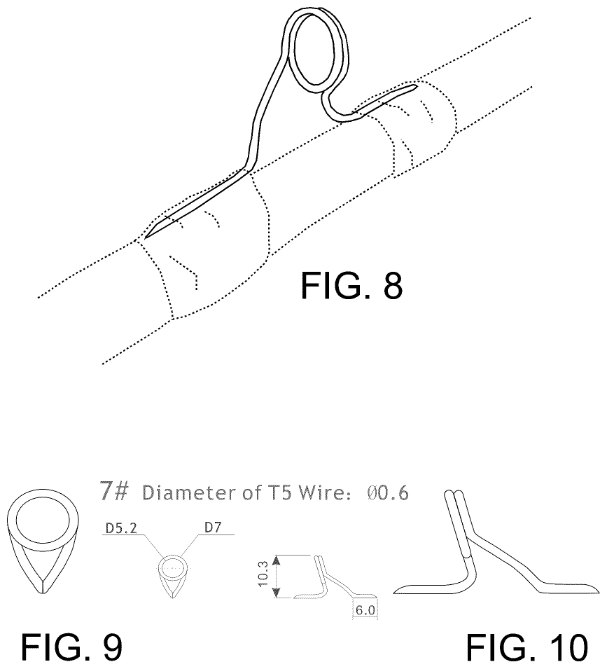

FIG. 8 is a perspective view of a casting model fishing rod line guide. FIG. 9 is a front view of the cast model fishing rod line guide. FIG. 10 is a side view of the casting model fishing rod line guide. FIGS. 8-10 present the casting model guide configuration optimized for baitcasting reel applications and 7# fishing lines. FIG. 8 provides a perspective view highlighting the casting-specific frame geometry, while FIG. 9 shows the front view and FIG. 10 depicts the side view profile. The casting model incorporates dimensional specifications of outer diameter (D7) of 7.0 millimeters outer measurement, and 5.2 millimeters inner dimension (D5.2). The frame has a height of 10.3 millimeters and two footings of 6.0 millimeters a piece. This configuration accommodates the different line management requirements of casting reels compared to spinning reels.

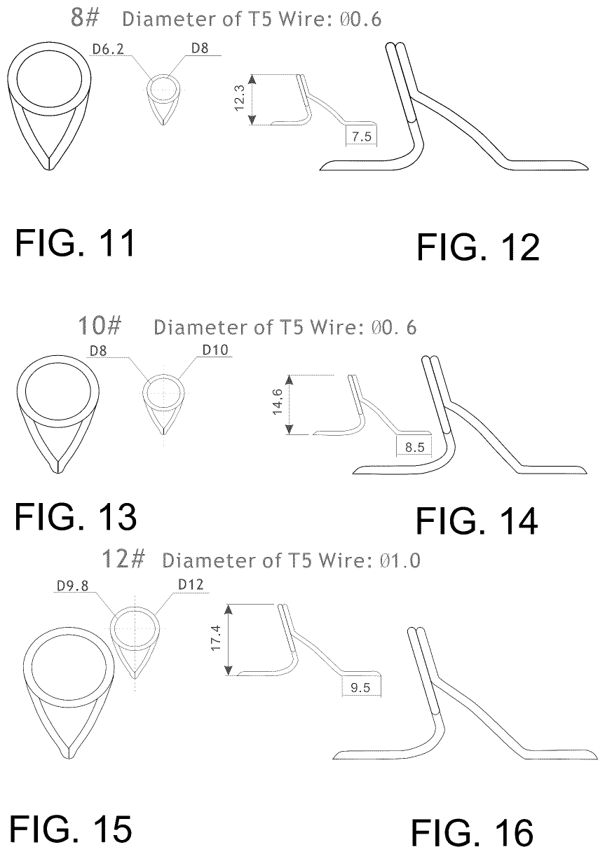

FIG. 11 is a front view of a second embodiment of a casting model fishing rod line guide. FIG. 12 is a side view of the second embodiment of the casting model fishing rod line guide. FIGS. 11 and 12 illustrate a second embodiment of the casting model guide. FIG. 11 shows the front view configuration while FIG. 12 presents the side view profile. This embodiment is optimized for 8# lines and sized with titanium alloy wire having a diameter of 0.6 millimeters, providing enhanced flexibility for medium-duty casting applications. As shown, the inner diameter (D6.2) is 6.2 millimeters and the outer diameter (D8) is 8 millimeters. The frame has a height of 12.3 millimeters and two footings of 7.5 millimeters a piece.

FIG. 13 is a front view of a third embodiment of a casting model fishing rod line guide. FIG. 14 is a side view of the third embodiment of the casting model fishing rod line guide. FIGS. 13 and 14 depict a third embodiment of the casting model guide optimized for heavier applications. FIG. 13 provides the front view while FIG. 14 shows the side view. This embodiment is optimized for 10# lines and sized with titanium alloy wire having a diameter of 0.6 millimeters, providing enhanced flexibility for medium-duty casting applications. As shown, the inner diameter (D8) is 8.0 millimeters and the outer diameter (D10) is 10 millimeters. The frame has a height of 14.6 millimeters and two footings of 8.5 millimeters a piece.

FIG. 15 is a front view of a fourth embodiment of a casting model fishing rod line guide. FIG. 16 is a side view thereof the fourth. FIGS. 15 and 16 present the fourth embodiment of the casting model guide designed for the heaviest applications. FIG. 15 shows the front view configuration while FIG. 16 depicts the side view profile. This embodiment is optimized for 10# lines and sized with titanium alloy wire having a diameter of 1.0 millimeters, providing enhanced flexibility for heavy-duty casting applications. As shown, the inner diameter (D9.8) is 9.8 millimeters and the outer diameter (D12) is 12 millimeters. The frame has a height of 17.4 millimeters and two footings of 9.5 millimeters a piece.

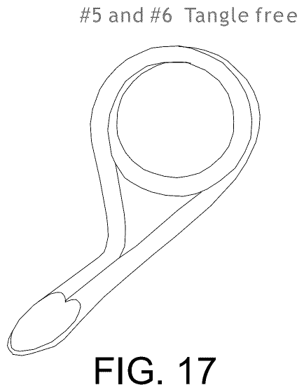

FIG. 17 is a perspective view of a running line guide. FIG. 17 illustrates a running line guide configuration in perspective view. This embodiment incorporates both #5 and #6 sizing options and features anti-tangle design characteristics while utilizing the innovative titanium alloy wire construction with nickel-PTFE coating. The running guide serves as intermediate guides along the fishing rod blank, requiring different dimensional specifications than tip or stripper guides.

All embodiments shown in the drawings utilize titanium alloy wire construction, which provides superior strength-to-weight ratio, corrosion resistance, and heat dissipation properties compared to conventional stainless steel guide frames. The entire wire surface receives treatment with an electroless nickel-PTFE coating that provides significantly lower coefficient of friction than traditional PVD coatings used on conventional guides. This coating combination enables the enhanced casting distance and accuracy, reduced line wear, and superior heat dissipation characteristics that distinguish the present invention from prior art fishing rod guides.

The anti-tangle and flexible frame geometry incorporated in all embodiments prevents fishing line from wrapping around the guide frame during casting or retrieval operations, addressing a persistent problem in conventional guide design. The flexibility of the fishing rod line guides is an important consideration for both casting performance and durability. By selecting titanium alloys with appropriate mechanical properties and by varying the wire diameter, the guide frames can be engineered to provide the desired balance between rigidity and flexibility. Thinner wire diameters and certain titanium alloys (e.g., commercially pure grades) offer increased flexibility, which can reduce the risk of frame breakage during high-impact fishing scenarios while still maintaining sufficient strength and corrosion resistance. Conversely, thicker wire diameters and higher-strength alloys (e.g., Grade 5) provide greater rigidity for heavier line applications. The dimensional specifications provided ensure optimal performance across the full range of fishing line weights from light freshwater applications to heavy saltwater big game fishing.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

The anti-tangle properties of these fishing rod guides result from carefully engineered dimensional relationships between the guide ring diameter, wire thickness, and frame geometry. The dimensional specifications from the T5 Guide documentation reveal critical design principles that prevent line wrapping. For spinning models, the relationship between outer diameter and inner diameter creates optimal clearances. The 12# spinning guide features a D20 outer diameter (20.0 mm) with a D16.8 inner diameter (16.8 mm), using 1.0 mm titanium alloy wire. This 3.2 mm radial clearance between the ring and frame creates sufficient space for fishing line to move freely without becoming trapped between the wire frame and ring surface. The progression of guide sizes demonstrates how dimensional scaling maintains anti-tangle properties across different line weights. The 10# guide reduces to D12 outer (12.0 mm) with D9.6 inner (9.6 mm) using 0.6 mm wire, maintaining a proportional 2.4 mm radial clearance. This consistent dimensional relationship ensures that regardless of guide size, fishing line cannot easily wrap around the frame structure.

The disclosed guides may feature three critical geometric elements: flared frame design, double-sloped ring positioning, and optimal frame height ratios. The forward-angled frame geometry creates a zone where looped line can slip forward and release automatically. This design feature is particularly noteworthy for the casting models, where the 20.0 mm, 17.0 mm, and 11.6 mm dimensional progression shows how the frame tapers to guide line smoothly without creating entanglement points.

The electroless nickel-PTFE coating provides the critical surface properties that enable the dimensional anti-tangle design to function effectively. With a coefficient of friction ranging from 0.08 to 0.12, compared to conventional PVD coatings at 0.20 or higher, the coating reduces line adhesion to guide surfaces. This low friction surface prevents fishing line from adhering to the guide frame, which adherence could otherwise cause a tangle. The PTFE coating's self-lubricating properties promotes sliding of any line contact with the frame rather than adhering. The electroless deposition process ensures uniform coating thickness across complex three-dimensional guide geometries, including the curved transitions between frame legs and ring mounting points where tangles typically initiate. This uniform coverage eliminates sticky points where conventional guides with uneven coating thickness can trap fishing line.

Heat generation during fishing occurs when line passes through guides under tension, particularly during long fish runs or high-speed retrieval. The titanium alloy wire construction provides thermal conductivity enabling rapid heat transfer away from the line contact zone. The dimensional specifications show how wire diameter scaling optimizes heat dissipation. Larger guides for heavier lines use 1.0-1.2 mm wire diameter, providing greater thermal mass and conduction area. Smaller guides for lighter lines use 0.6 mm wire, which offers sufficient heat dissipation for reduced friction loads while minimizing weight.

Suitably, the combination of ultra-low friction coating and optimized frame geometry creates synergistic anti-tangle effects that exceed the performance of either feature alone. The PTFE coating reduces the initial tendency for line to adhere to frame surfaces, while the dimensional relationships ensure that any line contact results in immediate release rather than progressive wrapping. The nickel-PTFE coating's hydrophobic properties also contribute to anti-tangle performance by repelling water that could otherwise create surface tension effects causing line to stick to wet guide frames. This is particularly important in saltwater applications where spray and splash constantly wet the guide surfaces. The coating's abrasion resistance ensures that the low-friction properties remain stable over thousands of fishing cycles. Unlike PVD coatings that can wear through at high-contact points, creating rough surfaces that grab line, the electroless nickel-PTFE coating maintains consistent surface properties throughout its service life.

The range of guide sizes demonstrates how dimensional relationships are optimized for different fishing line characteristics. Braided lines, with their smaller diameter and tendency to cut into guide surfaces, benefit from the ultra-smooth PTFE coating and larger clearance ratios. Monofilament lines, which can stretch and deform under load, require the anti-tangle frame geometry to prevent binding during tension changes. The progression from 6.0 guides (D7 outer, D5.2 inner) through 20 H casting guides shows how dimensional scaling maintains optimal performance across the full range of fishing applications. Each size maintains the critical clearance ratios that prevent line entrapment while providing adequate structural strength for the intended line weights.

The fishing rod line guides of the present invention may be constructed from a variety of titanium alloys, including but not limited to Grade 5 (Ti-6Al-4V), Grade 2, Grade 1, and other commercially available titanium alloys suitable for wire frame fabrication. The selection of titanium alloy and wire diameter allows for precise control over the mechanical properties of the guide, including strength, flexibility, and corrosion resistance. For example, thinner wire diameters and commercially pure titanium alloys (such as Grade 1 or 2) may be used where increased flexibility is desired, while thicker wire and higher-strength alloys (such as Grade 5) may be selected for applications requiring greater rigidity and durability. This flexibility ensures that the guides can accommodate a wide range of fishing line weights and fishing conditions without risk of premature failure.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

All original claims submitted with this specification are incorporated by reference in their entirety as if fully set forth herein.

I claim:

1. A fishing rod line guide system comprising:
a plurality of fishing rod guides configured for different fishing line weights, each guide having a titanium alloy wire frame with an outer diameter, an inner diameter, and a frame length;
wherein each guide maintains proportional dimensional relationships where the outer diameter to inner diameter ratio ranges from 1.15:1 to 1.35:1 across guide sizes from 6.0 guides having a 7.0 mm outer diameter to 20 H casting guides having a 20.0 mm outer diameter;
an electroless nickel-polytetrafluoroethylene coating applied to the titanium alloy wire frame, the coating having a coefficient of friction between 0.08 and 0.20;
wherein the titanium alloy wire diameter scales proportionally with guide size, ranging from 0.6 mm for guides supporting 6# to 10# fishing line to 1.2 mm for guides supporting 20 H casting applications;
wherein the combination of the proportional dimensional relationships and the electroless nickel-PTFE coating creates synergistic anti-tangle properties that prevent fishing line from wrapping around the guide frame during casting and retrieval operations; and
wherein the titanium alloy wire construction and electroless nickel-PTFE coating combination provides enhanced heat dissipation compared to conventional PVD-coated stainless steel guides

2. A method for optimizing fishing rod guide performance across multiple fishing line weights comprising:
selecting a titanium alloy wire diameter based on intended fishing line weight,
wherein wire diameter ranges from 0.6 mm for 6# to 10# line applications to 1.2 mm for 20 H casting applications;
forming a guide frame from the selected titanium alloy wire with outer and inner diameters maintaining a proportional clearance ratio of 1.15:1 to 1.35:1;
applying an electroless nickel-polytetrafluoroethylene coating to the formed guide frame to achieve a coefficient of friction between 0.08 and 0.20;
configuring frame geometry to create anti-tangle properties through the synergistic combination of the proportional dimensional relationships and ultra-low friction coating surface;
wherein the method creates dimensional scaling that maintains optimal performance characteristics including reduced line tangling, enhanced heat dissipation, and improved casting distance across guide sizes ranging from 6.0 guides with 7.0 mm outer diameter to 20 H casting guides with 20.0 mm outer diameter; and
wherein the electroless nickel-PTFE coating process ensures uniform coating thickness across the three-dimensional guide geometry, eliminating grab points that cause conventional guides to trap fishing line

3. A fishing rod guide system comprising:
a guide frame constructed from titanium alloy wire having superior thermal conductivity and strength-to-weight ratio compared to stainless steel;
an electroless nickel-polytetrafluoroethylene composite coating applied to all surfaces of the titanium alloy wire frame, the coating providing a coefficient of friction of 0.08 to 0.20 and uniform thickness across complex three-dimensional guide geometries;
frame geometry configured with proportional clearance between outer diameter and inner diameter ranging from 1.15:1 to 1.35:1, creating sufficient space for fishing line movement while preventing line entrapment;
wherein the electroless nickel-PTFE coating's hydrophobic properties repel water and prevent surface tension effects that cause line adhesion to conventional guide frames;
wherein the titanium alloy wire construction enables rapid heat transfer away from friction points, preventing line weakening caused by heat buildup during high-tension fishing operations;
wherein the synergistic combination of the ultra-low friction electroless nickel-PTFE coating and optimized frame geometry proportions creates anti-tangle properties that exceed the performance achievable by either feature alone; and
wherein the coating's abrasion resistance maintains consistent low-friction properties throughout the guide's service life, unlike PVD coatings that can wear through at high-contact points and create rough surfaces that grab fishing line.
